(19) United States
(12) Patent Application Publication
(10) Pub. No.: US 2024/0218629 A1
(43) Pub. Date: Jul. 4, 2024

(54) WATER DIGGER

(71) Applicant: Alexei Egmar KRASS DE KRASSNOKUTSKI, Johannesburg (AZ)

(72) Inventor: Alexei Egmar KRASS DE KRASSNOKUTSKI, Johannesburg (ZA)

(21) Appl. No.: 18/023,855

(22) PCT Filed: Aug. 31, 2021
(86) PCT No.: PCT/IB2021/057935

§ 371 Date: Feb. 28, 2023

(30) Foreign Application Priority Data
Aug. 31, 2020 (ZA) 2020/05406

(51) Int. Cl. E02F 3/06; E02F 5/00

(52) U.S. Cl. CPC E02F 3/06; E02F 5/006

(57) ABSTRACT

A water digger comprises three equi-spaced augers meeting near a lowest point. There are three buoys serving as floats for the water digger.

This invention relates to a Water Digger which is a spinning, mud-shearing device that in use serves for the enhanced dewatering of slimes ponds or tailing storage facilities (which are hereinafter referred to as “slimes dumps”).

These slimes dumps can be quite large and span many acres in the area. The slimes/tailings (hereinafter referred to as “mud”) normally comprise of considerable percentage of water (up to 70%), and where there is an excess of a certain amount, this can contribute to the susceptibility of the dump bursting. Needless to say, this is dangerous, causing fatalities and wasting time and money. It is necessary therefore to remove as much water as possible as soon as possible and this is where the water digger comes into effect.

According to one aspect of the invention there is provided a water digger comprising a central vertical portion which preferably spins, conveniently slowly, about its vertical axis; a number of, preferably three, floats located about the centre portion, and preferably rotatably connected to the central portion, and a number of, preferably three, augers preferably projecting substantially radially and horizontally from the central portion, each auger having its inner end connected to the central portion. The outer ends of the augers are preferably connected to the floats.

The augers are connected respectively to rotational means, preferably electric motors, for rotating the augers to draw the mud from beside the central portion to dig progressively a shallow pit into the underlying mud, the flights of the auger forming rotating shearing elements. The geometry of the water digger is variable during operation, most crucially, the inclination of the augers can be varied during operation which determines the depth of the pit being dug. In use, there will be an accumulation of so-called “bleed water” at the bottom of the pit which can be pumped out (or channelled away) and reclaimed as process water. Thus, in use, the solid concentration of the mud will increase and so too its yield stress. Consequently, the risk of the slime's dumps failing is reduced.

The floats conveniently comprise hollow spherical buoys which are preferably free to rotate on their horizontal axes to prevent unnecessary drag.

An embodiment of the invention will now be described by way of example with reference to the accompanying drawings.

In the drawings:

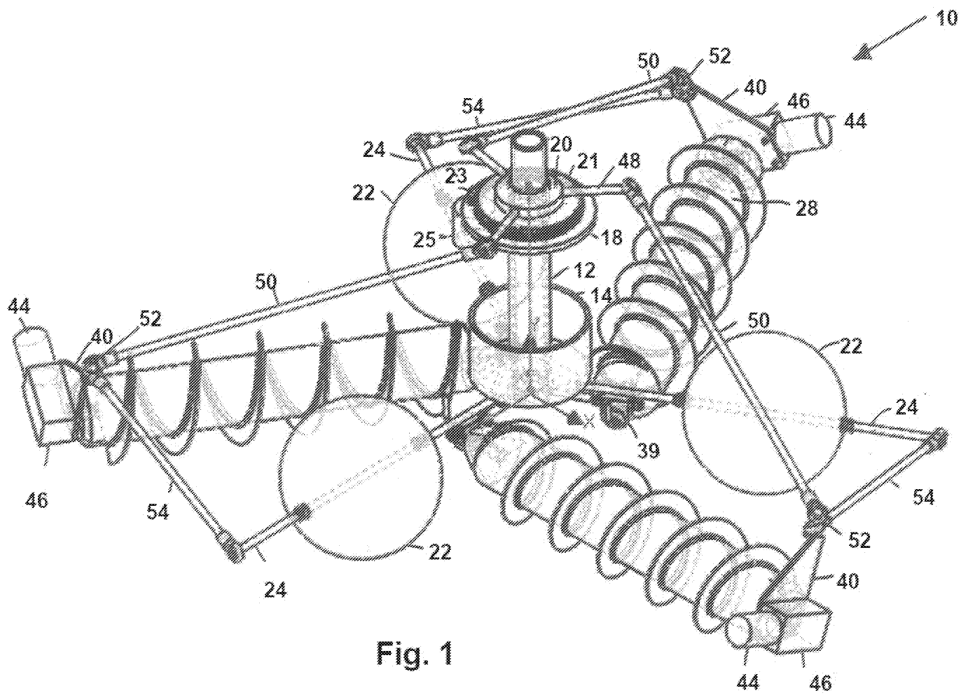

FIG. 1 is a perspective or isometric view of a water digger of the invention,

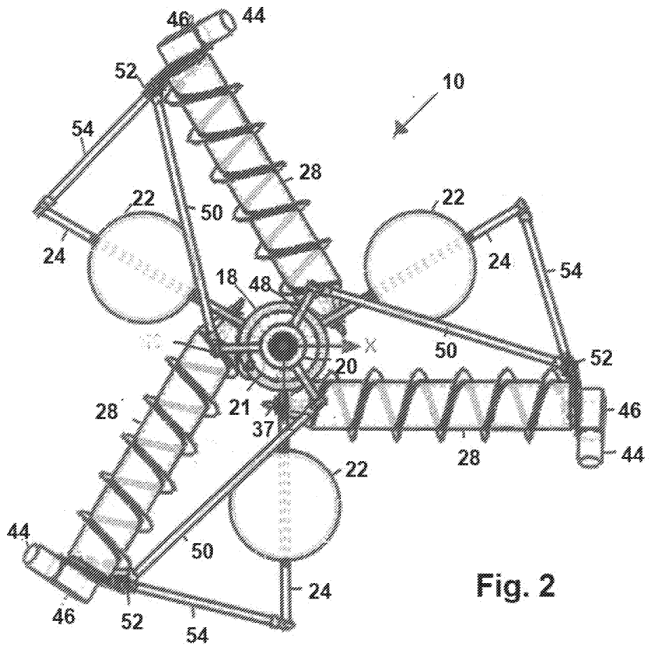

FIG. 2 comprises a plan view of the water digger,

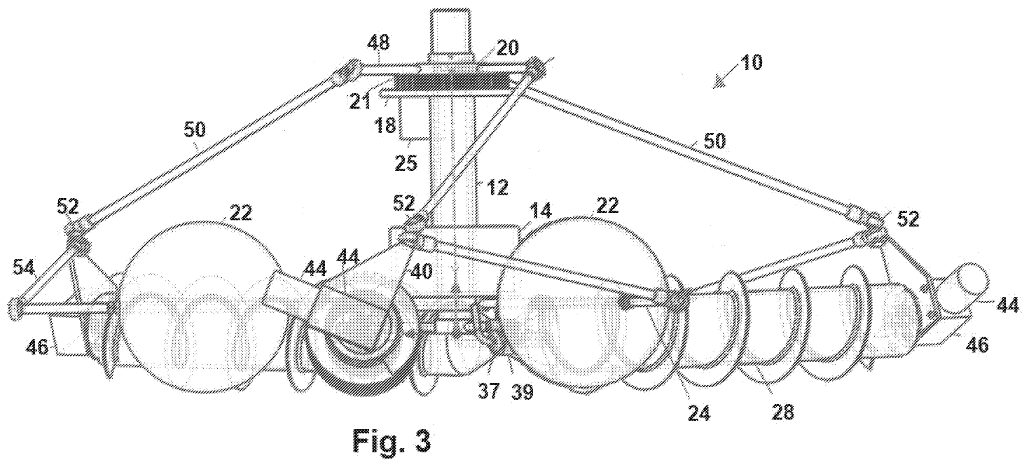

FIG. 3 is a front view of the water digger operating on horizontal surface,

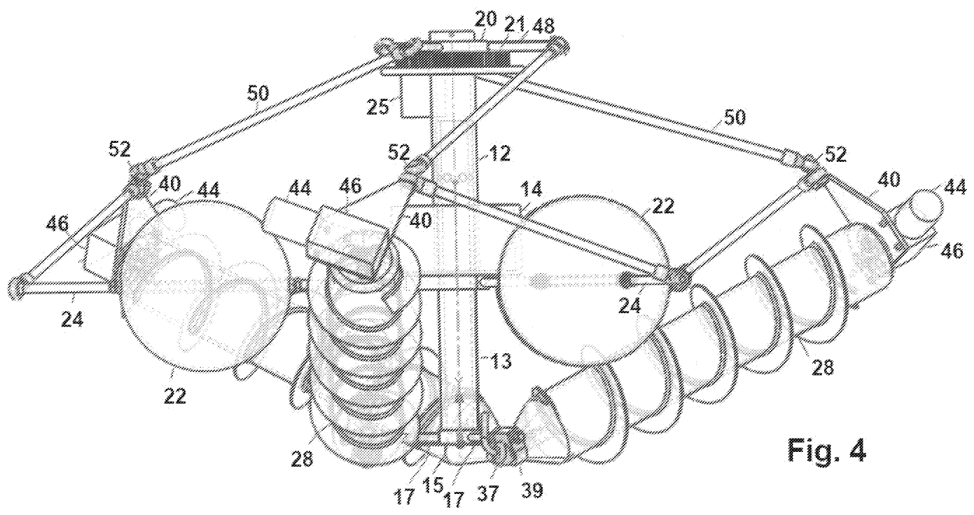

FIG. 4 is a front view of the water digger with a steep pit angle digging geometry,

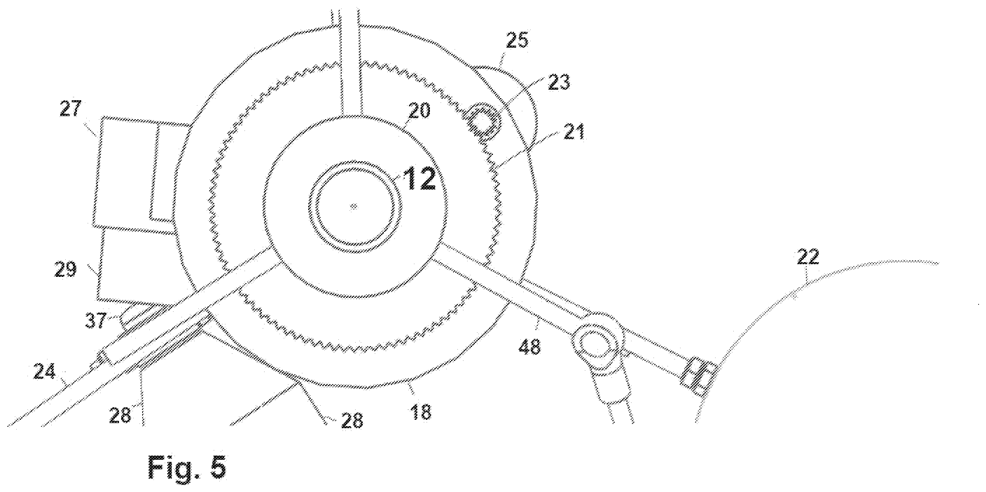

FIG. 5 is a detailed plan view of the geometry driving mechanism,

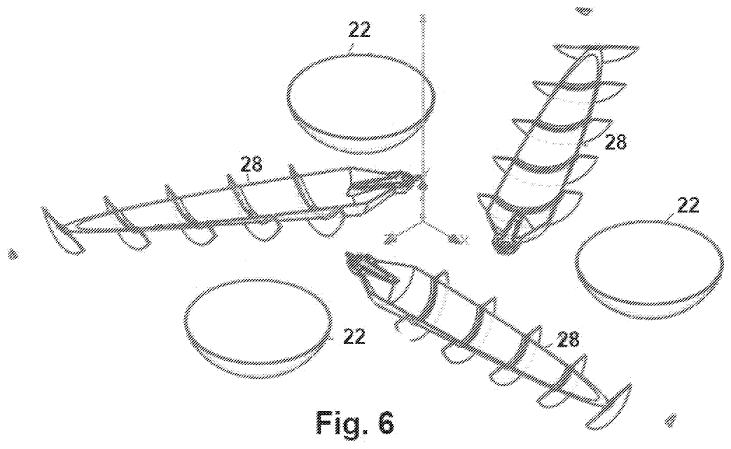

FIG. 6 is a horizontally sectioned view of the water digger operating at a shallow pit angle geometry, i.e., the component sections that would be under-water/mud,

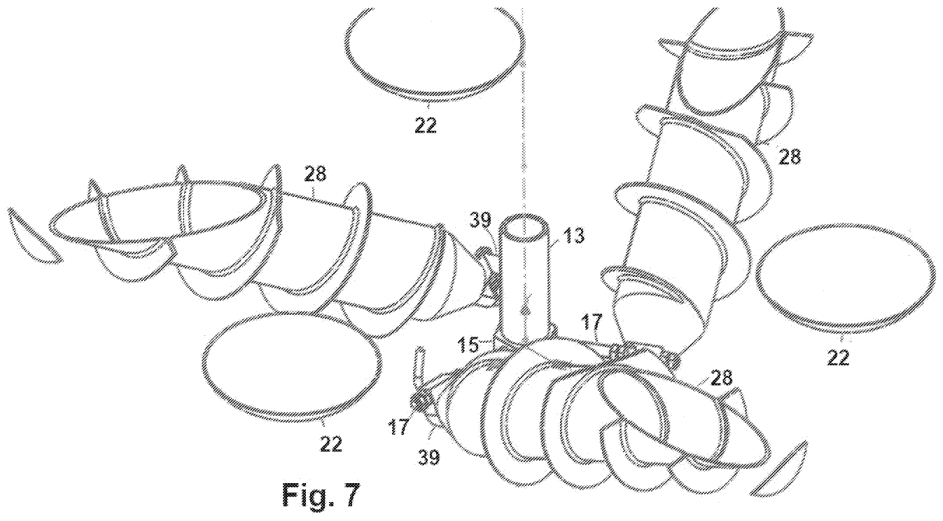

FIG. 7 is a horizontally sectioned view of the water digger operating at a steep pit geometry, i.e., showing the component sections that would be under-water if the pit was flooded,

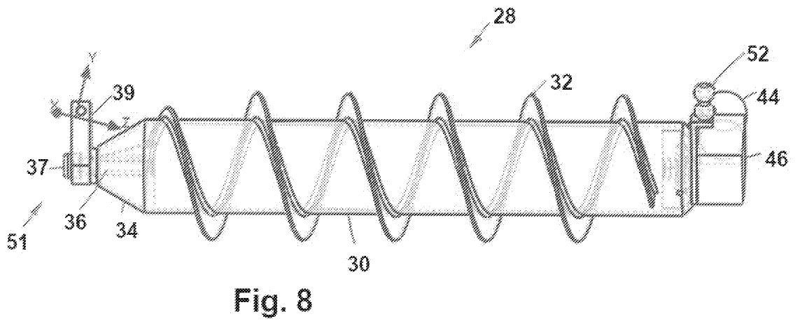

FIG. 8 is sectioned view of the hydrostatic bearing arrangement and auger connecting components,

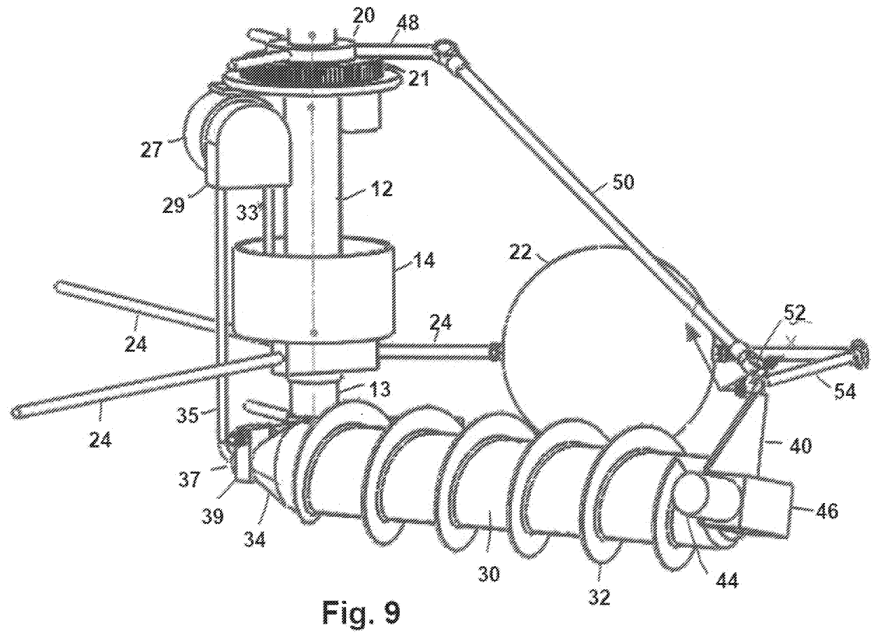

FIG. 9 is an isometric view of the hydrostatic bearing pump, reservoir and piping arrangement (feeding only 1 auger/bearing and buoy are shown).

Referring now to the drawings, there is shown a water digger 10 of the invention comprising a central outer vertical hollow tube 12 which coaxially surrounds an inner tube 13 that extends from near the upper end of the outer tube 12 and projects below the lower end of the outer tube 12. The outer tube 12 is surrounded near its lower end by a short hollow cylinder 14 of substantially greater diameter which forms a reservoir. The bottom end of the outer tube 12 surrounds an opening (not shown) in the base of the reservoir and is sealed to the base so that water can be contained therein. At its upper end the tube 12 has a flange 18 on which rotatably rests a spur gear 21 driving a collar 20.

Three equi-spaced floats, each in the form of a hollow spherical buoy 22, surround the cylinder 14. Each float is connected to the cylinder 14 by a horizontal radial pin 24 that passes therethrough and about which the buoy can rotate. The pin 24 projects beyond the buoy 22 for the purpose which will become apparent.

Three equi-spaced augers 28 are provided. Each auger has a main hollow body 30 surrounded by a helical flight 32. Each auger 28 has a frusto conical inner end 34 terminating in a pin 36. The remote end of each auger 28 is rotatably connected to a short plate 40 (Motor mount) which is normal to the auger. On the outside of each motor mount 40 there is a motor 44 driving a gearbox 46 which is connected to rotate the auger 28 relative to the motor mount 40.

The inner tube 13 provided within the outer tube 12 telescopically projects to an adjustable depth below the lower end of the outer tube 12 (see FIG. 4). At the bottom of the inner tube 13 is a collar 15 from which project three equally spaced radial rods 17. The ends of rods 17 each rotatably receive a hanger plate 39, thus connecting auger 28 to the central portion.

The collar 20 is fixedly connected to a large annular gear 21 which is co-axially rotatable on plate 18 (see FIG. 5). The plate has a peripheral flange with an inner recess in which a pinion 23 is received. The pinion protrudes from a motor/gearbox assembly 25 mounted on the underside of plate 18. The collar 20 above the gear 21 has three equally spaced radial rods 48 projecting slightly beyond the area of the cylinder 14. A first elongated connecting rod 50 rotatably connects the end of a radial rod 48 to a corner 52 of the nearest motor mount 40. A second connecting rod 54 also connects corner 52 of the motor mount 40 to the outside pin 24 radially beyond buoy 22.

A pump 29 is mounted on the outside of the reservoir 14 on the underside of the flange 18 (see FIG. 9). A motor 27 which is connected to the pump to drive it, is also mounted on the underside of plate 18. A suction pipe 33 leads from the pump to the floor of the reservoir 14. Three outlet pipes 35 (only one of which is shown in FIG. 9) lead from the pump respectively to the hydrostatic bearings 51 at the inner end of each auger 28.

An on-board control system/device operates the pump 29. In use the reservoir is filled with a hydrostatic lubricant (water) before each operation of the water digger. The lubricant is driven to the bearings so that each forms a hydrostatic bearing.

This enables the bearings to work adequately reasonable length of time notwithstanding the rough or dirty material in the water where the water digger works.

Each buoy 22 is capable of rotating about its associated pin 24. Further it will be seen that by rotating the collar 20 the angle of the axes of the augers 28 to the tube 12 can be adjusted (see FIG. 3 and FIG. 4). This in turn can adjust the slope angle of the pit being formed by the water digger 10. The collar 20 is rotated by the motor/gearbox assembly 25 by the onboard control system/device (see FIG. 5).

The water digger is supplied with electric power by:

### An Electrical Cable (not Shown).

The electric cable will be floated on the surface of the slimes dump by a series of buoys. Additionally, since the water digger is continually spinning, an electric slip ring (also not shown) is provided to connect the power cable to the water digger 10 and hence the various motors thereof.

### Self-Contained Battery Packs (Also not Shown).

This system is preferable as it would allow the water digger to operate autonomously without a cumbersome umbilical cord. However, a system would need to be developed to enable the battery packs to be replaced or recharged. Using batteries would introduces the possibility for the water digger to incorporate solar panels into the water digger's design which would contribute to the required power draw and thus extend its operating intervals between battery charges.

It will be seen that the water digger 10 is amphibious i.e., it is able to operate on a solid floor or on the mud surface of a deep slimes dump by varying the angles of the augers 24. In use the water digger 10 is placed in the mud or slimes dam as can best be calculated. The power cable is then connected to the water digger 10. By adjusting the angle of the collar 20 the angle of the augers is adjusted so that the angle of the pit that will be formed is adjusted. By means of the control device the speed of the various motors is adjusted. As the water digger rotates the flights 32 shear mud and move it radially away from the centre of the pit. The water will accumulate at the bottom of the pit and can be removed by being pumped out or channelled away. The solids concentration of the mud at the remote end of the auger will increase and so too does its yield strength. This reduces the risk of slimes dump failure.

The invention is not limited to the precise constructional details hereinbefore described and illustrated in the drawings. For example, the motors 44 may be capable of being driven at differential speeds depending on the water diggers orientation. This will develop an unbalanced force which will allow the water digger to move/walk across the mud surface. A brush system may be provided between the flights to prevent the mud dogging up the space between the flights. As each flight passes the brush, the bristles of the brush bend out of the way.

1. A water digger comprising a central portion; a number of floats located about the central portion; and a number of augers projecting substantially regularly and horizontally from the central portion, each auger having an inner end connected to the central portion, and the outer end connected to a float.

2. A water digger as claimed in claim 1 wherein the central portion is capable of rotating about its vertical axis.

3. A water digger as claimed in claim 1 and comprises three floats.

4. A water digger as claimed in 1 wherein the floats are equi-spaced about the central portion.

5. A water digger as claimed in claim 1 wherein the floats are formed from hollow spherical buoys.

6. A water digger as claimed in claim 1 wherein the floats are rotatably connected to the central portion to reduce drag.

7. A water digger as claimed in claim 1 comprising three augers.

8. A water digger as claimed in claim 1 wherein the augers project substantially radially and horizontally from t central portion.

9. A water digger as claimed in claim 1 wherein the augers are connected respectively to rotational means, for rotating the augers to draw the mud from beside central portion to dig progressively a shallow pit into the underlying mud.

10. A water digger as claimed in claim 9 wherein the flights of the auger form rotating shearing elements.

11. A water digger as claimed in claim 1 wherein the inner tube is movable axially within the outer tube to allow the inclination of the augers.

12. A water digger as claimed in claim 1 further comprising a reservoir and a pump connected to draw liquid from the reservoir and deliver it to hydrostatically bearings attached to the augers.

13. A water digger as claimed in claim 12 wherein the reservoir surrounds the lower end of the outer tube.

14. A water digger as claimed in claim 13 wherein the augers are capable of being rotated at different speeds relative to the water digger's orientation so that the water digger is movable across the mud surface.

15. A water digger as claimed in claim 1 wherein a device is provided to prevent the mud caking up between the flights.
